(19) United States
(12) Patent Application Publication
(10) Pub. No.: US 2026/0091505 A1
(43) Pub. Date: Apr. 2, 2026

(54) SUBSTRATE TRANSFER APPARATUS AND SUBSTRATE TRANSFER METHOD

(71) Applicants: KAWASAKI JUKOGYO KABUSHIKI KAISHA, Kobe-shi (JP); Kawasaki Robotics (USA), INC., Wixom, MI (US)

(72) Inventors: Haruhiko TAN, Kobe-shi (JP); Iori KURATA, San Jose, CA (US); Hajime NAKAHARA, San Jose, CA (US)

(73) Assignees: KAWASAKI JUKOGYO KABUSHIKI KAISHA, Kobe-shi (JP); Kawasaki Robotics (USA), INC., Wixom, MI (US)

(21) Appl. No.: 18/901,532

(22) Filed: Sep. 30, 2024

(51) Int. Cl. B25J 11/00; B25J 15/00

(52) U.S. Cl. CPC B25J 11/0095; B25J 15/0014; B25J 15/0033

(57) ABSTRACT

A substrate transfer method according to one or more embodiments is disclosed that may include moving a hand of a substrate transfer apparatus to a lower part of a substrate, moving a plunger of the substrate transfer apparatus to increase a pocket size that is a distance between a substrate contact portion of the hand and the plunger of the substrate transfer apparatus, picking up the substrate, and moving the plunger to decrease the distance between the substrate contact portion and the plunger of the substrate transfer apparatus and to a position that the substrate is not gripped.

### BACKGROUND

The disclosure relates to a substrate transfer apparatus and a substrate transfer method, particularly to a substrate transfer apparatus for gripping and transporting a semiconductor substrate or the like.

A plurality of manufacturing apparatus is used when manufacturing semiconductor substrates, liquid crystal substrates, panels, and the like (hereinafter referred to as substrates). A transfer apparatus is used to transfer substrates between these manufacturing devices. The transfer apparatus includes industrial robots.

The Japanese Patent Publication 2018-73942 (P2018-73942A) discloses a substrate gripping hand for gripping a disc-shaped substrate, which is provided with a guide member on the base plate, formed in an L-shape when viewed from the horizontally, and a horizontal portion is provided at the base end of the bottom surface of the guide member, and a first corner that is a corner formed by the bottom surface and the inner wall surface of the guide member is formed in a curved shape.

Japanese Patent Publication 2014-86472 (P2014-86472A) discloses a clamping device capable of holding and releasing the workpiece, including a tip side fixing block provided on the tip side, a base side fixing block provided on the base side, and a movable block on the work holding table. Each fixed block is formed with an upward-facing fixed inclined surface, and the movable block is formed with a downward-facing movable inclined surface, and when holding the workpiece, while the workpiece is placed straddling the upward fixed inclined surface, the movable block is advanced so that the downward movable inclined surface is in contact with the side of the workpiece, and when the workpiece is released from the work holding table, the movable block is retracted in the opposite direction from the workpiece.

### SUMMARY

A substrate transfer method according to one or more embodiments may include moving a hand of a substrate transfer apparatus to a lower part of a substrate; moving a plunger of the substrate transfer apparatus to increase a pocket size that is a distance between a substrate contact portion of the hand and the plunger of the substrate transfer apparatus, picking up the substrate; and moving the plunger to decrease the distance between the substrate contact portion and the plunger of the substrate transfer apparatus and to a position that the substrate is not gripped.

A substrate transfer method according to one or more embodiments may include moving a hand of a substrate transfer apparatus to a lower part of a substrate; picking up the substrate, determining if the substrate is placed on the hand; gripping the substrate when it is determined that the substrate is placed on the hand; and proceeding to a next process when it is determined that the substrate is placed on the hand.

A substrate transfer apparatus according to one or more embodiments may include an end effector including: a hand that comprises a substrate contact portion and grips a substrate; and a plunger that comes into contact with the substrate and aligning the substrate, the plunger comprising a contact portion that comes into contact with the substrate by moving in a direction of the substrate. In one or more embodiments, the plunger picks up the substrate by increasing a distance between the substrate contact portion and the contact portion.

### BRIEF DESCRIPTION OF DRAWINGS

FIG. 1 is a diagram illustrating an upper surface of a substrate transfer apparatus according to one or more embodiments.

FIG. 2 is a flowchart illustrating a substrate transfer method according to one or more embodiments.

FIGS. 3A and 3B are diagrams illustrating cross-sectional views of an operation of a substrate transfer method according to one or more embodiments.

FIG. 4 is a flowchart illustrating a substrate transfer method according to one or more embodiments.

FIG. 5 is a diagram illustrating a top view of a portion of an end effector of a substrate transfer apparatus according to one or more embodiments.

FIGS. 6A and 6B are diagrams illustrating for explaining an operation of a substrate transfer method according to one or more embodiments.

FIG. 7 is a diagram illustrating an upper surface of a substrate transfer apparatus according to one or more embodiments.

### DETAILED DESCRIPTION

The substrate transfer apparatus according to one or more embodiments is described in detail with reference to the drawings. In the description of the drawings, identical or similar parts may be indicated by the same or similar numerals. The description in the drawing is schematic, and the relationship between thickness and dimensions, the ratio of the length and thickness of each part, etc. are examples, and do not limit the scope of technical concept. The dimensional relationships and dimension ratios may vary between drawings. In the following description, when explaining the positional relationship of each component, “top”, “bottom”, “right side”, “left side”, etc. are appropriately used based on the orientation of the drawing to be referenced and the specific object, but these indications do not limit the scope of technical ideas. Expressions such as “top”, “bottom”, “right side”, “left side”, etc. may be used even when each part is not in contact. “Longitudinal direction” may mean the direction of the long side on the main surface of the member. “Width direction” may mean the direction of the short side on the main surface of the member. “Height direction” or “vertical direction” may mean a direction related to the thickness of the main surface of the member. In addition, the X axis, the Y axis, the Z axis, or a combination thereof may be displayed in the figure, and “X axis direction”, “Y axis direction”, and “Z axis direction” may be used in the specification or drawing to describe the direction.

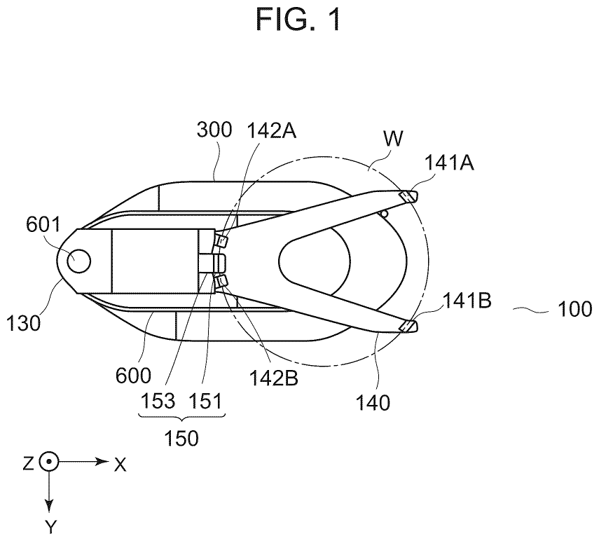

FIG. 1 is a diagram showing the upper surface of the substrate transfer apparatus 100 according to one or more embodiments. The substrate transfer apparatus 100 includes the base 300, the link 600 rotatably connected to the base 300, and the end effector 130 that is rotatably connected around the rotation shaft 601 and transports the substrate W. The substrate transfer apparatus 100 may include an extendable elevator (not shown) that may move the link 600 and the end effector 130 in the vertical direction (Z direction in the figure). Further, the substrate transfer apparatus 100 of FIG. 1 illustrates only one link 600, but is not limited to this, and may include two (2), three (3), four (4), and five (5) links 600. Further, the substrate transfer apparatus 100 may not include the link 600 and may directly connect the end effector 130 to the elevator. Further, the substrate transfer apparatus 100 may not include an elevator and may be directly connected with one or more links to the base 300. The substrate transfer apparatus 100 of FIG. 1 particularly indicates a horizontally articulated substrate type transfer apparatus 100, but is not limited to this, and a so-called direct-acting type substrate transfer apparatus that does not have a joint or a rotation mechanism may also be implemented. In the substrate transfer apparatus 100, various operations are controlled by a controller (not shown). The controller performs various operation controls including lifting and lowering operations and rotation operations of the elevator, link 600, and end effector 130 etc.

The end effector 130 includes the hand 140 that grips a substrate such as a semiconductor substrate or a liquid crystal substrate, and various panels (hereinafter collectively referred to as a substrate W), and a plunger 150 that grips and aligns the substrate in contact with the substrate W. The hand 140 includes substrate contact portions 141A, 141B, 142A, and 142B. The plunger 150 includes a contact portion 151 that may be moved to grip the substrate W, and the holder 153 that is connected to the contact portion 151 and moves the contact portion 151 based on the drive of the driver (not shown). Under the control of the controller, the end effector 130 acquires the substrate W from a predetermined position using the hand 140 and transports the substrate W to the predetermined position. When acquiring the substrate W stored in the FOUP (Front Opening Unified Pod) or the like, the hand 140 enters the upper or lower part of the substrate W, and when it is recognized that the hand 140 has entered to a predetermined position of the substrate W, the entry of the hand 140 is stopped. Thereafter, a gripping operation of the substrate W is performed. At this time, the contact portion 151 of the plunger 150 moves and grips the substrate W. As a method by which the hand 140 grips the substrate W, a so-called edge grip method may be used. In the edge grip method, the substrate W is held to some extent by the substrate contact portions 141A, 141B, 142A, and 142B, and the contact portion 151 is moved to contact with the substrate W. Thereby, the contact portion 151 grips the substrate W.

The substrate W includes a substrate such as a semiconductor substrate and a liquid crystal substrate, and various panels. For example, the substrate W shown in FIG. 1 is circular but is not limited thereto. The substrate W may be a transparent material containing a material that transmits light, or may be translucent, or non-transparent.

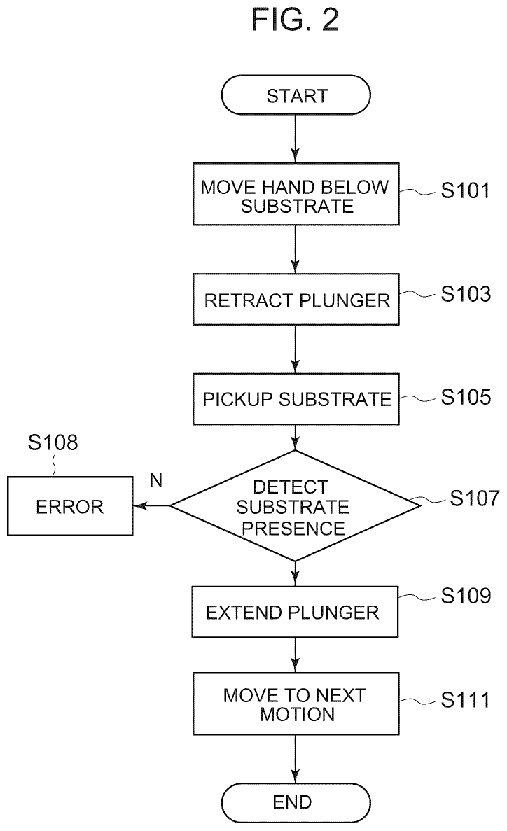

FIG. 2 is a flowchart illustrating a substrate transfer method according to one or more embodiments. The substrate transfer method according to one or more embodiments is described with reference to the substrate transfer apparatus 100 shown in FIG. 1 and the flowchart of FIG. 2. First, the hand 140 is moved to the lower part of the substrate W (step S101). Next, the plunger 150 retracts and moves the contact portion 151 in a direction away from the substrate W (in the opposite direction in the X direction of FIG. 1) (step S103). The contact portion 151 of the plunger 150 is connected to the holder 153. The holder 153 may be connected to a shaft (not shown). The holder 153 or shaft may be connected to a driver (not shown) that generates a driving force. By applying power to the holder 153 or the shaft, the driver performs a reciprocating motion in the longitudinal direction of the holder 153 (X direction in FIG. 1), for example. With the reciprocating motion of the shaft, the shaft or the holder 153 also moves back and forth. Thereby, the contact portion 151 reciprocates in the X direction of FIG. 1. The contact portion 151 is driven by a driver and recedes in the opposite direction of the X direction shown. Thereby, the contact portion 151 of the plunger 150 is moved in a direction away from the substrate W. Since the contact portion 151 has moved away from the substrate W, the distance between the contact portion 151 and the substrate contact portions 141A and 141B (may be referred to as pocket size) is increased. Next, the substrate transfer apparatus 100 picks up the substrate W (step S105). To pick up of the substrate W, the end effector 130 is moved in the upward direction (Z direction in FIG. 1). The movement of the end effector 130 may be performed by an elevator for moving the end effector 130 in the vertical direction. A moving device may also be provided separately for moving the end effector 130 in the vertical direction. Since the pocket size is increased in step S103, the risk of collision between the substrate W and the substrate contact portions 141A and 141B and the contact portion 151 may be reduced when the substrate W is picked up. Next, detection is made as to whether or not the substrate W is placed on the end effector 130 (step S107). The method for detecting the substrate W may be the method described later, or another method may be used. When it is detected that the substrate W is not placed on the end effector 130 by step S107, error processing is performed (step S108). When it is detected that the substrate W is placed on the end effector 130 by step S107, the plunger 150 is extended, and the contact portion 151 moves in a direction approaching the substrate W (X direction in FIG. 1) (step S109). The contact portion 151 of the plunger 150 is driven by a driver and moves in the X direction shown in the figure. As a result, the contact portion 151 of the plunger 150 moves in a direction approaching the substrate W. Since the contact portion 151 moves in a direction approaching the substrate W, the pocket size between the contact portion 151 and the substrate contact portions 141A and 141B is shortened. At this time, the pocket size may be decreased so as not to grip the substrate W. Further, when the plunger 150 is moved in a direction approaching the substrate W, the plunger 150 may be stopped after the pocket size is decreased to the extent that it does not grip the substrate W. Specifically, for example, when the substrate is circular and the diameter is 300 mm, the pocket size may be between 0.1 mm and 0.8 mm, or between 0.2 mm and 0.5 mm. Thereafter, the process moves on to the next operation (step S111).

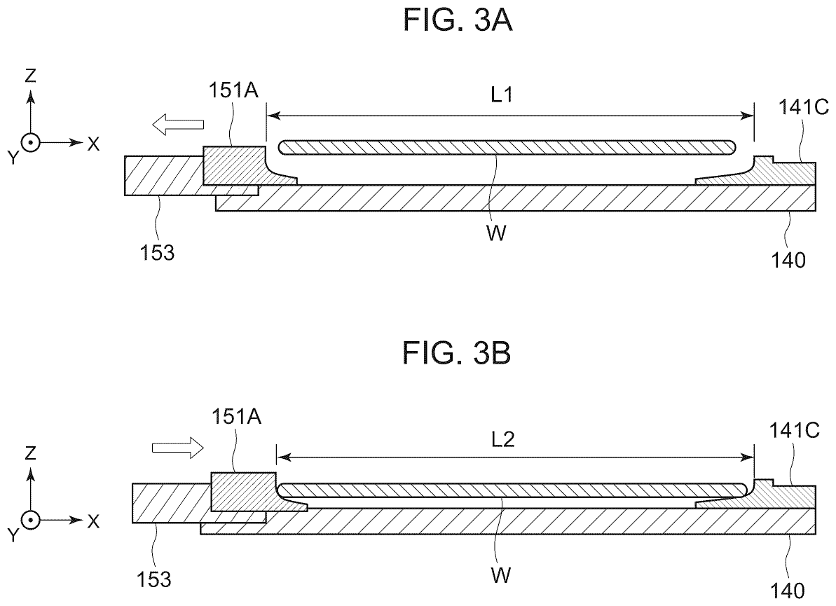

Thus, in one or more embodiments, during the pick-up operation of the substrate W, the plunger 150 is moved to enlarge the pocket size to pick up the substrate W. Thereafter, the plunger 150 is moved to decrease the pocket size. By increasing the pocket size In this way, damage to the substrate W due to the collision between the substrate W and the plunger 150 when picking up the substrate W may be reduced. Further, during the pick-up operation of the substrate W, the plunger 150 is moved to increase the pocket size and the substrate W is picked up. For this reason, it may not be necessary to extend the contact portion 151 of the plunger 150 or the substrate contact portions 141A and 141B of the hand 140 in the height direction (Z direction in FIG. 3A). Therefore, the thickness of the end effector 130 may be reduced. On the other hand, after picking up the substrate W, the pocket size is decreased to reduce the gap between the contact portion 151 of the plunger 150 or the substrate contact portions 141A and 141B of the hand 140 and the substrate W. Thereby, when the substrate W is moved, damage to the substrate W due to contact with the plunger 150, the substrate contact portion 141A, and the like may be reduced. Further, by reducing the gap between the plunger 150 and the substrate W, the fluttering of the substrate W when moving the substrate W may be reduced. In general, the gripping operation of the substrate is that after the plunger 150 comes into contact with the substrate, the plunger 150 is further moved in the direction of the substrate W so that the contact portion 151 of the plunger 150 and the substrate contact portions 141A and 141B of the hand 140 reliably grip the substrate W. In this case, there is concern about damage to the substrate W. According to the substrate transfer apparatus according to one or more embodiments, by reducing the pocket size to the extent of reducing the fluttering of the substrate W when moving the substrate W, it may be possible to reduce the damage to the substrate W caused by contact with the plunger 150 and the substrate contact portion 141A etc. when the substrate W is moved.

FIGS. 3A and 3B are cross-sectional views illustrating the operation of a substrate transfer method according to one or more embodiments. The operation of the substrate transfer apparatus according to one or more embodiments is described with reference to the flowchart shown in FIG. 2. First, after the hand 140 moves to the lower part of the substrate W (step S101), the plunger 150 retracts (step S103). As the plunger 150 retracts, the contact portion 151A connected to the holder 153 moves away from the substrate W (in the opposite direction of the X direction of FIG. 1). The holder 153 may be connected to a shaft (not shown). The holder 153 or shaft may be connected to a driver (not shown) that generates a driving force. By applying power to the holder 153 or the shaft, the driver performs a reciprocating motion in the longitudinal direction of the shaft (X direction in FIG. 1), for example. The contact portion 151 moves in the X direction of FIG. 3A with the reciprocating motion of the holder 153 or the shaft. In this way, the contact portion 151A retracts in the opposite direction of the X direction shown in the figure (arrow direction of FIG. 3A) by the driving force of the driver. Since the contact portion 151A moves away from the substrate W, the pocket size that is the distance between the contact portion 151A and the substrate contact portion 141C becomes longer. In this state, the pocket size between the contact portion 151A and the substrate contact portion 141C is L1. Next, the substrate W is picked up (step S105). To pick up the substrate W, the end effector 130 is moved upward (Z direction of FIG. 3A). Since the pocket size L1 is increased in step S103, the risk of collision between the substrate W and the substrate contact portion 141C or the contact portion 151 may be reduced when the substrate W is picked up. Next, the plunger is extended (step S107). By extending the plunger, the contact portion 151A moves in a direction approaching the substrate W (X direction in FIG. 3B). The contact portion 151A is driven by a driver and moves in the X direction shown in the figure (arrow direction in FIG. 3B). As a result, the contact portion 151A moves in a direction approaching the substrate W. Since the contact portion 151A moves in the direction approaching the substrate W, the pocket size between the contact portion 151A and the substrate contact portions 141A and 141B is decreased. In this state, the pocket size between the contact portion 151A and the substrate contact portion 141C is a pocket size L2 shorter than L1. The pocket-sized L2 between the contact portion 151A and the substrate contact portion 141C may be at a distance such that the contact portion 151A and the substrate contact portion 141C do not grip the substrate W. Further, when moving the contact portion 151A in the direction approaching the substrate W, the plunger 150 may be stopped just before it comes into contact with the substrate W. For example, when decreasing the pocket size, the plunger 150 may be stopped just before the contact portion 151A and the substrate contact portions 141A and 141B comes in contact with the substrate. Alternatively, when decreasing the pocket size, the plunger 150 may be stopped when either the contact portion 151A or the substrate contact portion 141C comes in contact with the substrate W. Regarding the stop position of the plunger 150, for example, when the substrate W is circular, the plunger 150 may be stopped at a place where the pocket size is between 0.03% and 0.3% of the diameter of the substrate W, or between 0.06% and 0.2% of the diameter of the substrate W. For example, when the substrate W is circular and the diameter is 300 mm, the pocket size may be between 300.1 mm and 300.8 mm, or between 300.2 mm and 300.5 mm. Thereafter, the process moves on to the next operation (step S109). The plunger 150 shown in FIGS. 3A and 3B includes the holder 153 and a contact portion 151A connected to the holder 153, but the plunger may not be limited to the configuration. For example, the holder and the contact portion may be integrally formed, or the plunger may be made into a rod shape and the drive from the driver may be directly transmitted to the substrate. In this case, the plunger may be rod-shaped, for example, cylindrical, and its cross-section may be implemented in a circle, an oval, a triangle, a square, a pentagon, or the like. Further, this contact portion is not limited to the shape shown in FIG. 3A. For example, the contact portion may be a cylindrical shape in which the upper surface is circular when viewed from the opposite direction from the Z direction of FIG. 3A. When the contact portion is cylindrical, it may be a shaped like an hourglass, with the center portion of the side surface is indented from the upper surface to the bottom surface of the cylindrical shape. In this way, having the contact portion with a cylindrical shape in which the central part of the side is constricted may make it easy to receive the substrate and reduce the damage to the substrate.

The contact portion 151A according to one or more embodiments includes a contact bottom surface which is the bottom surface that the substrate W contacts, and a contact side surface which is the side surface that the substrate contacts, and a contact boundary surface that connects the contact bottom surface and the contact side surface. As shown in FIGS. 3A and 3B, the contact bottom surface of the contact portion 151A is inclined so that its thickness decreases toward the tip direction (X direction). In other words, the contact bottom surface slopes in the opposite direction to the Z direction toward the tip direction. The contact side surface extends almost vertically (Z direction). The contact boundary surface is curved in an arc. The contact portion 151A is not limited to this shape, and for example, the contact side surface of the contact portion 151A may be oriented approximately vertically (Z direction) and then gently curved in the X direction. In other words, the vertex in the Z direction of the contact side surface of the contact portion 151A may be located in the X direction than the contact boundary surface. Further, the contact bottom surface of the contact portion 151A may be tilted so that the thickness is reduced while gently curving toward the tip direction (X direction). In other words, the contact bottom surface may be gently curved toward the tip and tilted in the opposite direction to the Z direction.

Thus, according to the moving method of the substrate transfer apparatus according to one or more embodiments, when picking up the substrate W, the plunger 150 is retracted to expand the pocket size. Thereby, a possibility of damage to the substrate W due to contact between the contact portion 151C and the substrate due to the storage error of the substrate W stored in the FOUP or the like may be reduced. Further, after picking up the substrate W, the plunger 150 may be moved forward and the plunger 150 may be temporarily stopped just before gripping the substrate W. Thereby, damage to the substrate W may be reduced when the contact portion 151C and the substrate W collide. Furthermore, after picking up the substrate W, the gap between the plunger 150 and the substrate W is reduced by decreasing the pocket size. Thereby, when the substrate W is moved, damage to the substrate W due to contact with the contact portion 151C, the substrate contact portion 141A etc. may be reduced. Further, by reducing the gap between the contact portion 151C and the substrate W, the fluttering of the substrate W when moving the substrate W may be reduced.

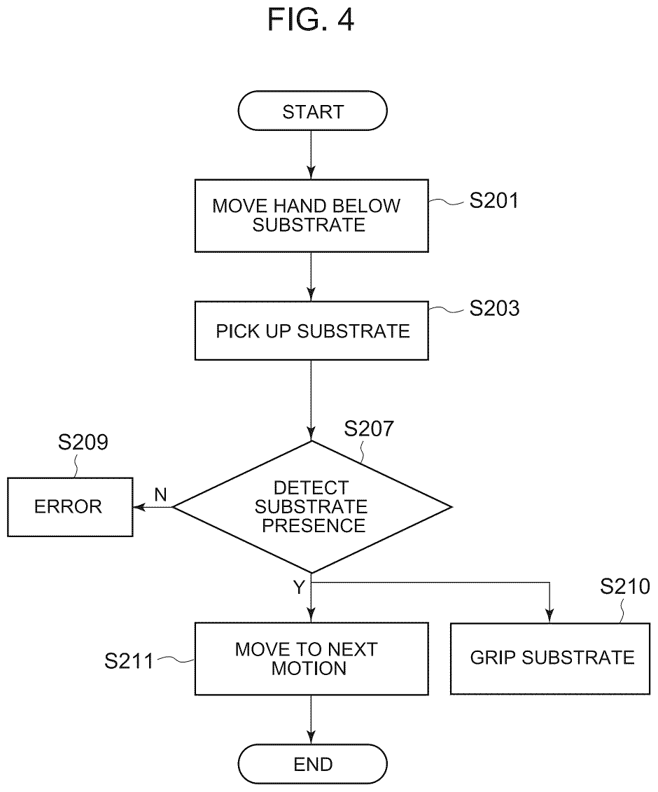

FIG. 4 is a flowchart illustrating a substrate transfer method according to one or more embodiments. The substrate transfer method according to one or more embodiments is described with reference to the substrate transfer apparatus shown in FIG. 1 and the flowchart of FIG. 4. First, the hand 140 is moved to the lower part of the substrate W (step S201). Next, the hand 140 picks up the substrate W (step S203). When picking up the substrate W, the operation of step S103 in the flowchart of FIG. 2 may be performed. That is, the plunger 150 may be retracted to increase the pocket size. Next, after performing a pick-up operation (step S203) of the substrate W, detection is made whether or not the substrate W is placed on the end effector 130 (step S207). When it is detected by step S207 that the substrate W is not placed on the end effector 130, error processing is performed (step S209). When it is detected that the substrate W is placed on the end effector 130 by step S207, the process moves on to the next operation (step S211). In addition, the substrate transfer apparatus decreases the pocket size by moving the plunger forward. Thereby, the substrate transfer apparatus grips the substrate W (step S210). Here, “gripping the substrate W” includes holding the substrate W by applying a predetermined pressure from the side (thickness surface) of the substrate W at the contact portion 151 of the plunger 150 and the substrate contact portions 141A and 141B of the hand 140.

In the substrate transfer method according to one or more embodiments, the operation of step S211 and step S210 may be executed in parallel. For example, the operation of step S211 and the operation of step S210 may be started at the same time, or the operation of step S211 may be started first and the operation of step S210 may be started without waiting for the completion of the operation of step S211, furthermore, the operation of step S211 may be started first and the operation of step S210 may be started without waiting for the completion of the operation of step S211. Hereinafter, the operation of these steps is described. In step S211, the plunger 150 grips the substrate W. Before gripping the substrate W, the operation of step S107 in the flowchart of FIG. 2 may be performed. That is, the plunger 150 may be extended to decrease the pocket size, and the extension of the plunger may be temporarily stopped before gripping. The gripping speed of the plunger 150 may be reduced when the plunger 150 grips. In other words, when gripping the plunger 150, the plunger 150 may be moved slowly. Specifically, after detecting that the substrate W is placed on the end effector 130 by step S207, the time of the gripping of the plunger 150 may be between 0.2 seconds and 2 seconds, and preferably between 0.4 seconds and 1 second.

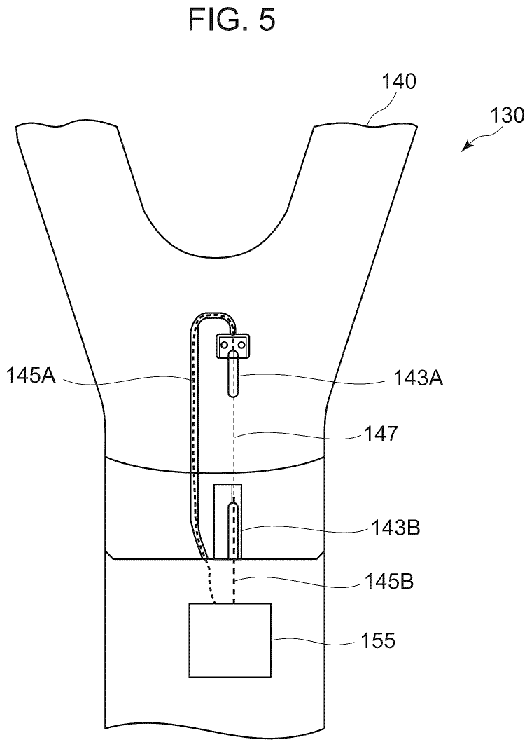

FIG. 5 is a top view showing a portion of the end effector 130 of the substrate transfer apparatus 100 according to one or more embodiments. The end effector 130 shown in FIG. 5 includes sensors 143A and 143B in the hand 140. The sensor 143A is electrically connected to the controller 155 through the wiring 145A. Further, the sensor 143B is electrically connected to the controller 155 through the wiring 145B. The controller 155 controls the sensors 143A and 143B, and communicates with the sensors 143A and 143B. The communication method of the sensors 143A and 143B includes communication by a light beam sensor, an infrared sensor, a radio wave sensor, an ultrasonic sensor, a microwave sensor, and the like. For example, based on the control of the controller 155, the sensor 143A emits light 147, and the sensor 143B detects the light 147. When the substrate W is placed between the sensor 143A and the sensor 143B, the light 147 is blocked and the sensor 143B may not detect light. The sensor 143B may detect whether or not the substrate W is placed on the end effector 130 based on the presence or absence of light detection. Here, the sensor 143A and the sensor 143B may include a WOB (Wafer on board) sensor.

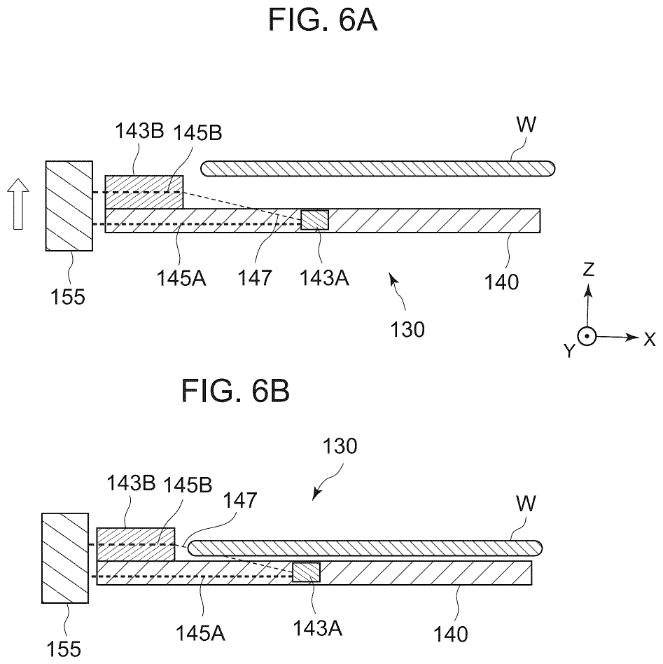

FIGS. 6A and 6B are diagrams illustrating the operation of a substrate transfer method according to one or more embodiments. With reference to FIGS. 6A and 6B, a method for determining whether or not the substrate W is placed on the end effector 130, which is the operation of step S207 of the flowchart shown in FIG. 4. In FIG. 6A, the end effector 130 includes a hand 140, sensors 143A and 143B that detect whether or not the substrate W is placed on the end effector 130, and a controller 155 that controls sensors 143A and 143B. The sensor 143A is built into the hand 140. This configuration may reduce the interference of the substrate W with the sensor 143A when the substrate W is gripped. The sensor 143B is located on the hand 140 and is placed in a position where it may communicate with the sensor 143A. Further, the sensors 143A and 143B are placed at a position where the substrate W is detected. The sensor 143B may not be placed on the hand 140 as long as it is in a position where it may communicate with the sensor 143A, and where the placement of the substrate W is detected. Here, the sensor 143A may be a transmitter that transmits light 147, and the sensor 143B may be a receiver that receives light 147. Further, the sensor 143B may be a transmitter that transmits light 147, and the sensor 143A may be a receiver that receives light 147. Based on the control of the controller 155 as shown in FIG. 6A, the sensors 143A and 143B communicate using the light 147. When acquiring the substrate W stored in the FOUP (Front Opening Unified Pod) or the like, the hand 140 enters the lower part of the substrate W. Thereafter, the hand 140 performs a pick-up operation of the substrate W. During the pickup operation, the end effector 130 moves upward (in the Z direction shown in the figure). At this time, when the end effector 130 is moved in the upward direction as shown in FIG. 6B, the substrate W blocks the light 147, and the sensors 143A and 143B detect the placement of the substrate W.

When the placement of the substrate W is detected in step S207, the operation proceeds to step S211 for the next operation. On the other hand, when the light 147 is not blocked even if the hand 140 is moved to a predetermined position, the sensors 143A and 143B detect the non-placement of the substrate W. When the non-placement of the substrate W is detected, the operation proceeds to step S209 to perform error processing.

As described above, in the substrate transfer method according to one or more embodiments, when detection of whether or not the substrate W is placed by the sensors 143A and 143B is completed, steps S210 and S211 are performed. As a result, to the next operation S211 may be performed before completing the gripping operation, thereby reducing the impact on throughput. In addition, since the gripping operation reduces the effect on throughput, there is more time to grip the substrate W. Therefore, since the movement of the plunger 150 may be slowed down, the possibility of damage to the substrate W may be reduced. As described above, according to the substrate transfer method and the substrate transfer apparatus according to one or more embodiments, it may be possible to perform a substrate griping operation while reducing the damage to the substrate W without reducing the throughput of the substrate gripping of the substrate transfer apparatus.

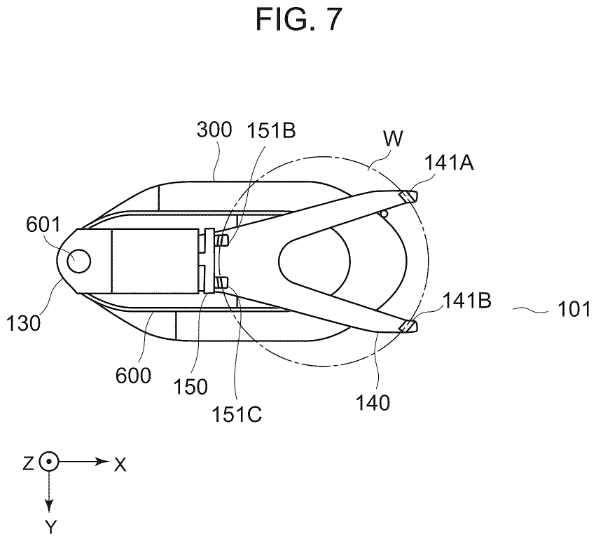

FIG. 7 is a diagram showing the upper surface of the substrate transfer apparatus 101 according to one or more embodiments. The substrate transfer apparatus 101 includes the base 300, the link 600 rotatably connected to the base 300, and the end effector 130 that is rotatably connected around the rotation shaft 601 and transports the substrate W. The substrate transfer apparatus 101 may include an extendable elevator (not shown) that may move the link 600 and the end effector 130 vertically (in the Z direction shown in the figure). Although only one link 600 is illustrated in FIG. 6, the substrate transfer apparatus 101 is not limited to this and may include two (2), three (3), four (4), and five (5) links 600. Further, the substrate transfer apparatus 101 may not include the link 600 and may directly connect the end effector 130 to an elevator (not shown). Furthermore, the substrate transfer apparatus 100 may not include an elevator and may be directly connected to one or more links to the base 300. The substrate transfer apparatus 101 of FIG. 7 particularly indicates a horizontally articulated substrate transfer apparatus 101, but is not limited to this, and a so-called direct-acting type substrate transfer apparatus that does not have a joint or a rotation mechanism may also be implemented. In the substrate transfer apparatus 101, various operations are controlled by a controller (not shown). The controller performs various operations of the elevator, link 600, and end effector 130 etc., including lifting and lowering operations and rotation operations.

The end effector 130 includes a hand 140 that grips a substrate such as a semiconductor substrate or a liquid crystal substrate and various panels, and a plunger 150 that grips and aligns the substrate in contact with the substrate W. The hand 140 includes substrate contact portions 141A and 141B. The plunger 150A includes a plurality of contact portions 151B and 151C that may be moved to grip the substrate W. Under the control of the controller, the end effector 130 acquires the substrate W from a predetermined position using the hand 140 and transports the substrate W to the predetermined position. When acquiring the substrate W stored in the FOUP (Front Opening Unified Pod) or the like, the hand 140 enters the upper or lower part of the substrate W, and when it is recognized that the hand 140 has entered to a predetermined position on the substrate W, the entry of the hand 140 is stopped. Thereafter, a gripping operation of the substrate W is performed. At this time, a plurality of contact portions 151B and 151C of the plunger 150A move and grips the substrate W. As a method by which the hand 140 grips the substrate W, a so-called edge grip method may be used. In the edge grip method, the substrate W is held to some extent by the contact portions 151B and 151C and the substrate contact portions 141A and 141B, and the contact portions 151B and 151C are moved to contact the substrate W. Thereby, the contact portions 151B and 151C grip the substrate W.

One or more embodiments described above herein may be combined with each other as far as practicable within the scope of the intended embodiment. The above examples are exemplary in all respects and should be considered not limiting. The illustrated and described embodiments may be extended to include other embodiments in addition to those specifically delivered, without departing from the technical scope. The technical scope should be determined not only by the foregoing description, but also in the light of the specification containing equivalents. Thus, all configurations, including the technical and equal ranges, are intended to be included in the technical range. The entire contents of U.S. patent application Ser. No. 18/901,497, filed on Sep. 30, 2024, entitled “SUBSTRATE TRANSFER APPARATUS AND SUBSTRATE TRANSFER METHOD” are incorporated herein by reference.

1. A substrate transfer method comprising:
moving a hand of a substrate transfer apparatus to a lower part of a substrate;
moving a plunger of the substrate transfer apparatus to increase a pocket size that is a distance between a substrate contact portion of the hand and the plunger of the substrate transfer apparatus;
picking up the substrate; and
moving the plunger to decrease the distance between the substrate contact portion and the plunger of the substrate transfer apparatus and to a position that the substrate is not gripped.

2. The substrate transfer method according to claim 1, further comprising
stopping moving the plunger after moving the plunger of the substrate transfer apparatus to decrease the distance between the substrate contact portion and the plunger.

3. The substrate transfer method according to claim 2, wherein
the plunger movement is stopped at a position where at least one of the substrate contact portion and the plunger does not contact the substrate when decreasing the distance between the substrate contact portion and the plunger.

4. The substrate transfer method according to claim 1, wherein
a contact portion of the plunger in contact with the substrate comprises:
a contact bottom surface that is a bottom surface in contact with the substrate;
a contact side surface that is a side surface in contact with the substrate; and
a contact boundary surface connecting the contact bottom surface and the contact side surface, wherein
the contact bottom surface is inclined so that a thickness decreases toward a tip direction.

5. The substrate transfer method according to claim 4, wherein
the contact boundary surface is curved.

6. A substrate transfer method comprising:
moving a hand of a substrate transfer apparatus to a lower part of a substrate;
picking up the substrate;
determining if the substrate is placed on the hand;
gripping the substrate when it is determined that the substrate is placed on the hand; and
proceeding to a next process when it is determined that the substrate is placed on the hand.

7. The substrate transfer method according to claim 6, further comprising:
moving a plunger of the substrate transfer apparatus to increase a distance between a substrate contact portion of the hand and the plunger, after moving the hand of the substrate transfer apparatus to the lower part of the substrate.

8. The substrate transfer method according to claim 7, further comprising:
moving the plunger of the substrate transfer apparatus to decrease the distance between the substrate contact portion and the plunger.

9. The substrate transfer method according to claim 6, wherein
a contact portion of a plunger in contact with the substrate comprises:
a contact bottom surface that is a bottom surface in contact with the substrate;
a contact side surface that is a side surface in contact with the substrate; and
a contact boundary surface connecting the contact bottom surface and the contact side surface, wherein
the contact bottom surface is inclined so that a thickness decreases s toward a tip direction.

10. The substrate transfer method according to claim 9, wherein
the contact boundary surface is curved.

11. A substrate transfer apparatus comprising:
an end effector comprising:
a hand that comprises a substrate contact portion and grips a substrate; and
a plunger that comes into contact with the substrate and aligns the substrate, the plunger comprising a contact portion that comes into contact with the substrate by moving in a direction of the substrate, wherein
the plunger picks up the substrate by increasing a distance between the substrate contact portion and the contact portion.

12. The substrate transfer apparatus according to claim 11, wherein
the plunger decreases the distance between the substrate contact portion and the contact portion after picking up the substrate, and grips the substrate.

13. The substrate transfer apparatus according to claim 11, wherein
the end effector further comprises a sensor that detects a placement of the substrate, wherein
the gripping of the substrate is started before completing detection of the placement of the substrate by the sensor.

14. The substrate transfer apparatus according to claim 11, wherein
the contact portion of the plunger in contact with the substrate comprises:
a contact bottom surface that is a bottom surface in contact with the substrate;
a contact side surface that is a side surface in contact with the substrate; and
a contact boundary surface connecting the contact bottom surface and the contact side surface, wherein
the contact bottom surface is inclined so that a thickness decreases toward a tip direction.

15. The substrate transfer apparatus according to claim 14, wherein
the contact boundary surface is curved.
